(19) United States
(12) Patent Application Publication
(10) Pub. No.: US 2008/0016478 A1
(43) Pub. Date: Jan. 17, 2008

(54) PARASITIC IMPEDANCE ESTIMATION IN CIRCUIT LAYOUT

(75) Inventors: Robert J. Lutz, Chippewa Falls, WI (US); Joel Ficke, Chippewa Falls, WI (US)

Correspondence Address: SCHWEGMAN, LUNDBERG & WOESSNER, P.A., P.O. BOX 2938, MINNEAPOLIS, MN, 55402, US

(73) Assignee: Cray Inc.

(21) Appl. No.: 11/777,094

(22) Filed: Jul. 12, 2007

Related U.S. Application Data
(63) Continuation-in-part of application No. 10/921,066, filed on Aug. 18, 2004, now abandoned.
(60) Provisional application No. 60/496,167, filed on Aug. 18, 2003.

(51) Int. Cl. G06F 17/50

(52) U.S. Cl. 716/5

(57) ABSTRACT

The present invention in one embodiment performs estimation of parasitic impedances in a circuit. Leaf cells of circuit components are evaluated such that their parasitic impedances are estimated, and the leaf cells are placed in a physical layout. Parasitic impedances of interconnect wiring is evaluated, and the interconnect wire routing is placed. Parasitic impedance within the circuit is then estimated using a parasitic reduction process.

### CLAIM OF PRIORITY

This application is a continuation-in-part of U.S. patent application Ser. No. 10/921,066 filed Aug. 18, 2004, which claims the benefit under 35 U.S.C. 119(e) of U.S. Provisional Application Ser. No. 60/496,167 filed Aug. 18, 2003, which applications are incorporated by reference and made a part hereof.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2007, Cray, Inc.

### FIELD OF THE INVENTION

The invention relates generally to laying out electronic circuits, and more specifically in one embodiment to estimating parasitic impedances in laying out electronic circuits.

### BACKGROUND OF THE INVENTION

Electronic circuits typically utilize various electronic components arranged in a useful way to form a useful circuit or arrangement of components. Common circuits include analog circuits, such as those designed to create, modulate, filter, or otherwise process analog signals that have values that are designed to vary across a continuous range of voltage levels. Similarly, digital circuits are made up of components designed to process digital information, which has one of a discrete number of values. Typical digital computers, for example, use components to handle digital signals varying between a reference voltage level of zero volts and a single higher voltage level, such as 3.3 volts.

But, in reality, the components that are used to make analog and digital circuits are not perfect, and the conductive traces that link various circuit elements themselves are not perfect. Printed circuit boards and integrated circuits alike suffer from resistance, capacitance, and inductance that are not intended but are a natural part of the circuit.

A capacitor employed in a circuit, for example, will likely appear within the circuit to have a certain amount of inductance and resistance, due in part to the inductance and capacitance of the conductive leads that connect the capacitor to other components as well as from the capacitor's own imperfections. These unintended impedances are often known as parasitic impedances, and are of concern in designing both analog and digital circuits due to the effects they can have on the circuit's speed, performance, and efficiency.

It is therefore desirable to consider parasitic impedances when designing a circuit.

### SUMMARY

The present invention in one embodiment performs estimation of parasitic impedances in a circuit. Leaf cells of circuit components are evaluated such that their parasitic impedances are estimated, and the leaf cells are placed in a physical layout. Parasitic impedances of interconnect wiring is evaluated, and the interconnect wire routing is placed. Parasitic impedance within the circuit is then estimated using a parasitic reduction process.

### BRIEF DESCRIPTION OF THE FIGURES

FIG. 1 is a flowchart of an example method of practicing one embodiment of the present invention.

FIG. 2A is a capacitance v. net width plot for input nets as is used in an example embodiment of the invention to estimate capacitances for input nets.

FIG. 2B is a capacitance v. net width plot for output nets as is used in an example embodiment of the invention to estimate capacitances for output nets.

FIG. 2C is a capacitance v. net width plot for internal nets as is used in an example embodiment of the invention to estimate capacitances for internal nets.

FIG. 3A-B is a diagram illustrating a series of steps for performing leaf cell parametric estimation, consistent with an example embodiment of the invention.

FIG. 4A-D comprises C code to calculate an estimated leaf cell parasitic capacitance, consistent with an example embodiment of the invention.

FIG. 5A-B comprises SKILL code to calculate shortest Manhattan distances, consistent with an example embodiment of the invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention in one embodiment performs estimation of parasitic impedances in a circuit. Leaf cells of circuit components are evaluated such that their parasitic impedances are estimated, and the leaf cells are placed in a physical layout. Parasitic impedances of interconnect wiring is evaluated, and the interconnect wire routing is placed. Parasitic impedance within the circuit is then estimated using a parasitic reduction process.

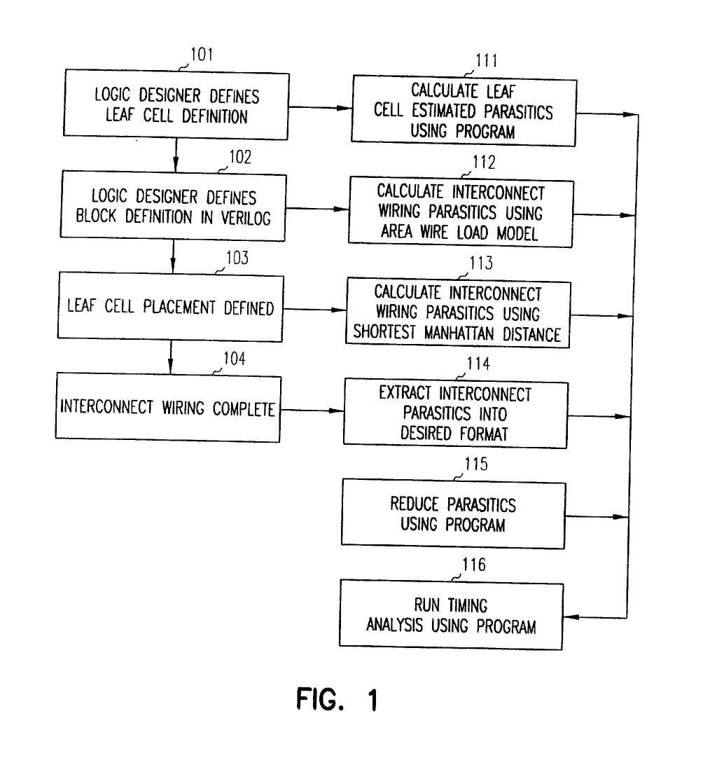

FIG. 1 is a flowchart illustrating one example method of practicing an embodiment of the present invention. At 101, the logic designer designs a leaf cell definition, such as by using a software program or other tool designed to enable definition of a circuit element. A leaf cell is in one embodiment one or more components that make up a sub-circuit element, such that multiple sub-circuit elements are combined to form the intended electronic circuit under design. For example, in digital circuit design, leaf cells are often defined for many common logic gates that are likely to be used repeatedly in a larger circuit.

At 102, a block definition for the leaf cell is created in a circuit layout tool, such as Verilog. Leaf cell placement within the larger circuit is defined at 103, and interconnect wiring coupling the various leaf cells and other components or sub-circuits is performed at 104. At 111, parasitic impedances within the leaf cell defined at 101 are calculated. Interconnect wiring parasitics are calculated or estimated at 112 using an area wire-load model, and interconnect wiring parasitics are calculated or estimated using a shortest Manhattan distance at 113. The interconnect parasitics are extracted from the calculated and estimated data into a desired format at 114, and are reduced at 115. Reduction comprises in one example evaluation of what parasitics are likely to have a significant effect on circuit performance, and discarding those not likely to have an effect determined to be significant.

Timing analysis of the circuit layout is then performed at 116, to confirm or verify circuit performance. The impact of parasitic impedances on one or more particular circuit layouts can thereby be analyzed and compared, and circuit layouts with a desired or acceptable level of parasitic impedances can be found. The order of the functions performed in FIG. 1 in various embodiments will be repeated or performed in various orders to facilitate refinement of a circuit layout or retrying circuit layout and interconnections to obtain a desired or acceptable circuit configuration.

Leaf cell parasitics as estimated at 111 will in some examples be calculated by application of an estimation algorithm to actual leaf cell layouts to tailor parameters of the estimation algorithm to the physical characteristics of the actual leaf cells, and use of the estimation algorithm to estimate parasitics for new leaf cells before layout.

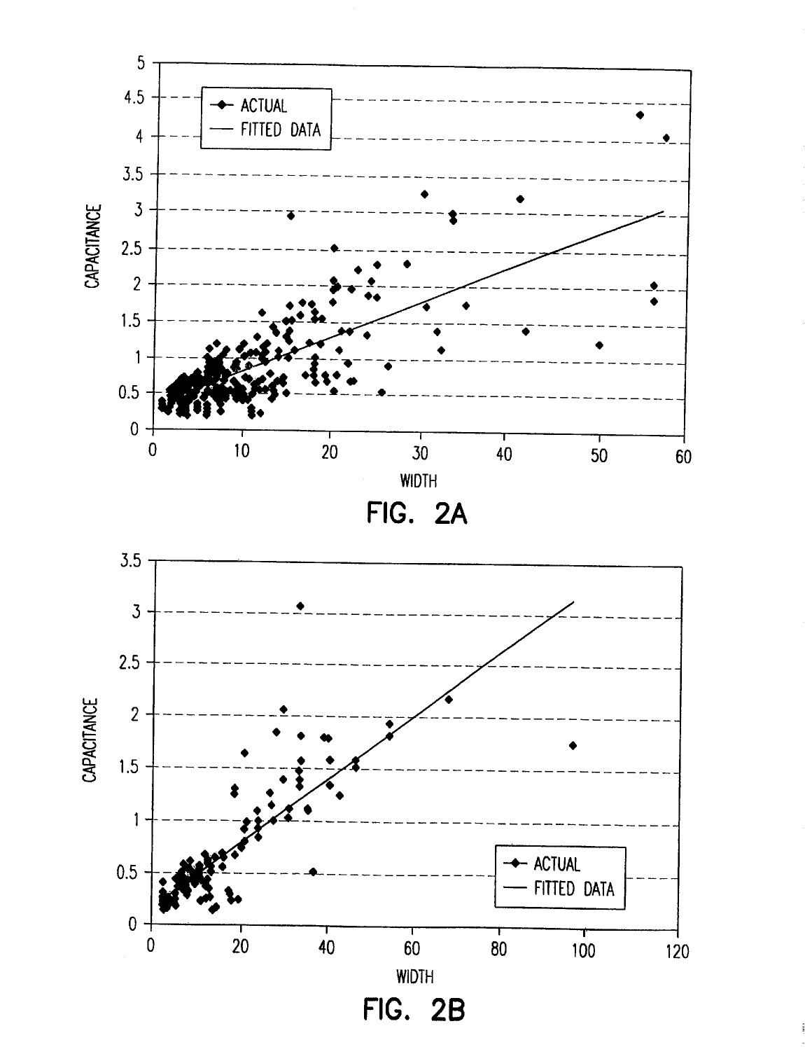

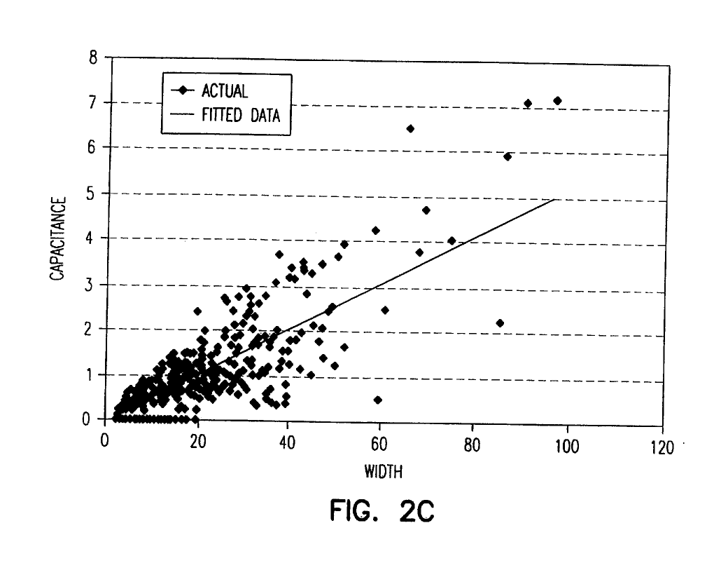

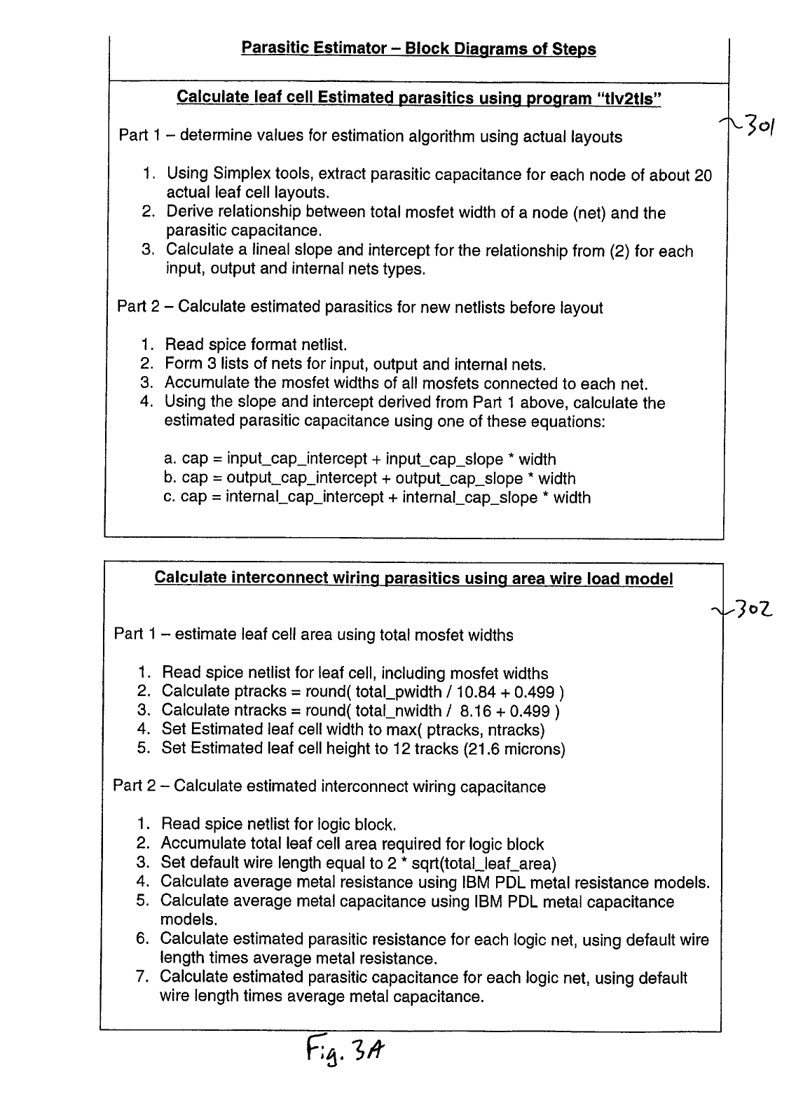

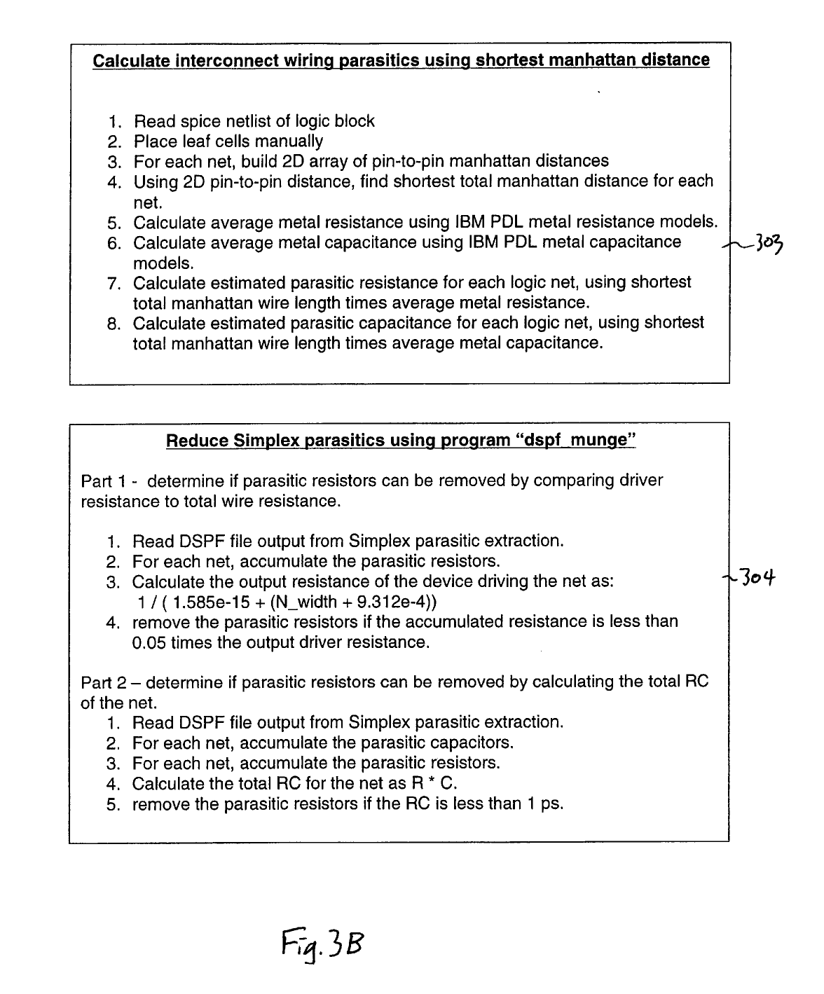

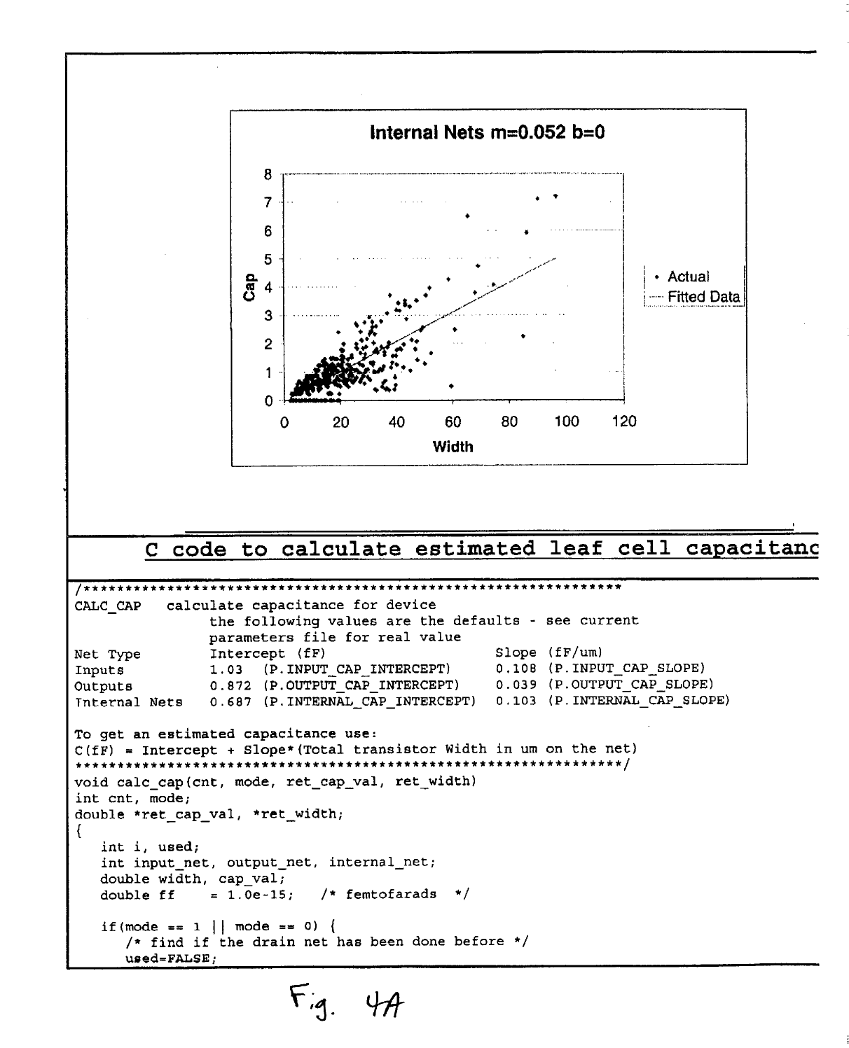

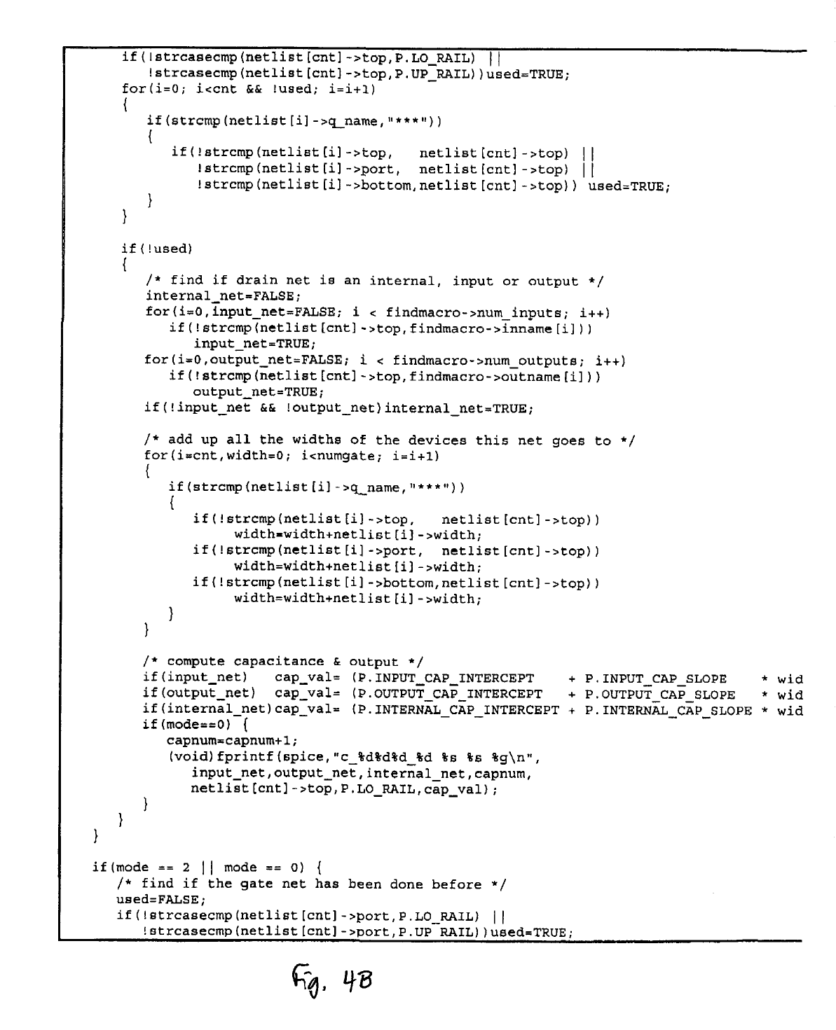

Parameters can be determined using actual leaf cells by processes such as extracting parasitic impedances for each node of a variety of leaf cells, and deriving a relationship between the total transistor device width of a node and the parasitic capacitance. A linear slope and intercept can be determined characterizing the width to parasitic capacitance relationship for input, output, and internal devices. This is illustrated in FIGS. 2A, 2B, and 2C, which illustrate capacitance versus transistor device width for input nets, output nets, and internal nets respectively. The dots are actual measured physical device data, and the line is a fitted estimation of the relationship between capacitance and device width for each net or transistor device type. The fitted line can then be used to estimate the parasitic capacitance of new devices or nets within a leaf cell or circuit.

The area wire load model in one embodiment involves estimation of the total device widths within the leaf cell, and estimating the interconnect wiring capacitance and resistance using models. In one embodiment, the total wire length in the leaf cell is estimated by he area of the leaf cell, such as by setting a default wire length of two times the square root of the total leaf area. The default wire length is then applied to the wire resistance and capacitance models to derive an area wire load model estimation of the leaf cell's wire load parasitic impedances.

Shortest Manhattan distance estimation as is shown at 113 in one example comprises placing leaf cells, such as by manually laying them out or placing them by some other means, and applying impedance wire models to the shortest Manhattan distance linking the various points that are to be connected via interconnect wires. Manhattan distances are determined by traveling from point to point along axes that are at right angles, such as by driving a car from place to place along streets laid out at right angles to one another. An array of 2-d Manhattan distances is assembled in one example, and the shortest manhattan distance for each net is selected. The total wire length of all interconnects is then compiled and applied to average metal resistance and capacitance models, and estimated parasitic resistance and capacitance for the leaf cell are determined.

Reduction of parasitics in one example is performed by determining whether a parasitic impedance is so insignificant that it may be disregarded. For example, parasitic resistances are discarded in one embodiment if they are less than 0.05 times the output driver resistance of the device driving the net. It is anticipated that resistances this low will not significantly change the performance of the circuit, and so can be discarded for estimation and simulation purposes.

Similarly, resistances can be disregarded in some examples if the RC time constant calculated for the net or device from estimated net parasitic capacitance and resistance by simply multiplying the resistance and capacitance values. The resulting value is the RC time constant in seconds. The parasitic resistance can be discarded in some examples if the resulting estimated RC time constant is less than a predetermined period of time, such as one picosecond.

FIG. 3A-B is a diagram illustrating a series of steps for performing leaf cell parametric estimation, consistent with an example embodiment of the invention. At 301, the leaf cell parasitics are calculated in a first program, as is described at 111 of FIG. 1. Similarly, interconnect wiring parasitics are calculated at 302, as are described at 112 of FIG. 1. At 303, the shortest Manhattan distance wiring parasitics are calculated, as shown at 113 of FIG. 1. The parasitics are reduced at 304, as is shown at 115 of FIG. 1.

The elements of FIG. 3 are in some embodiments performed using standard software packages, such as those provided by Simplex Solutions, Inc., Cadence Designs Systems, Inc., Mentor Graphics Corp., or other vendors. In other embodiments, one or more of the functions described are performed by custom software or by other means, such as by using C code, or scripts written to in various design package languages.

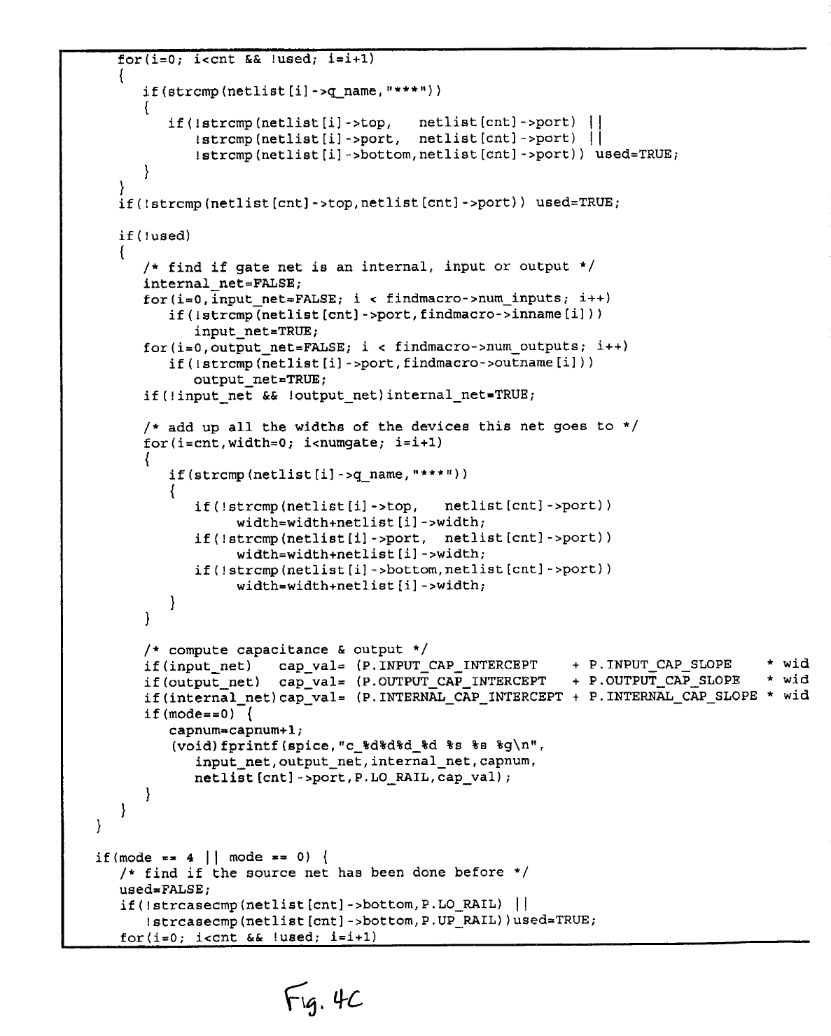

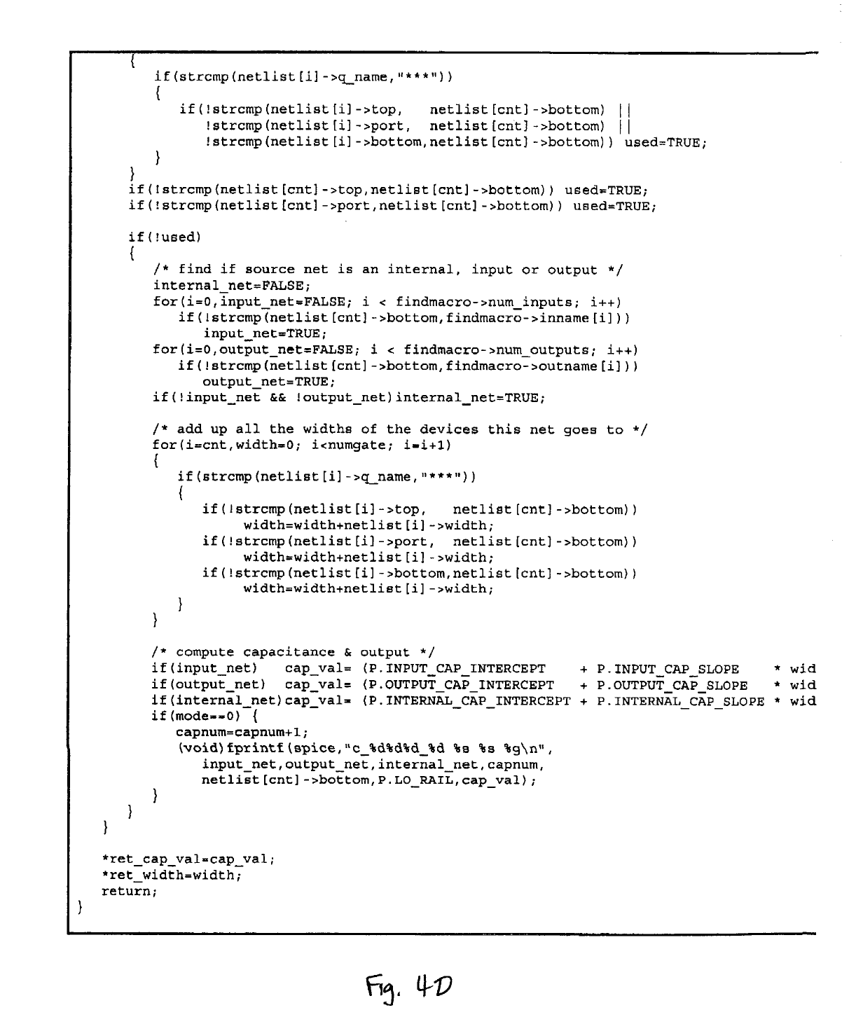

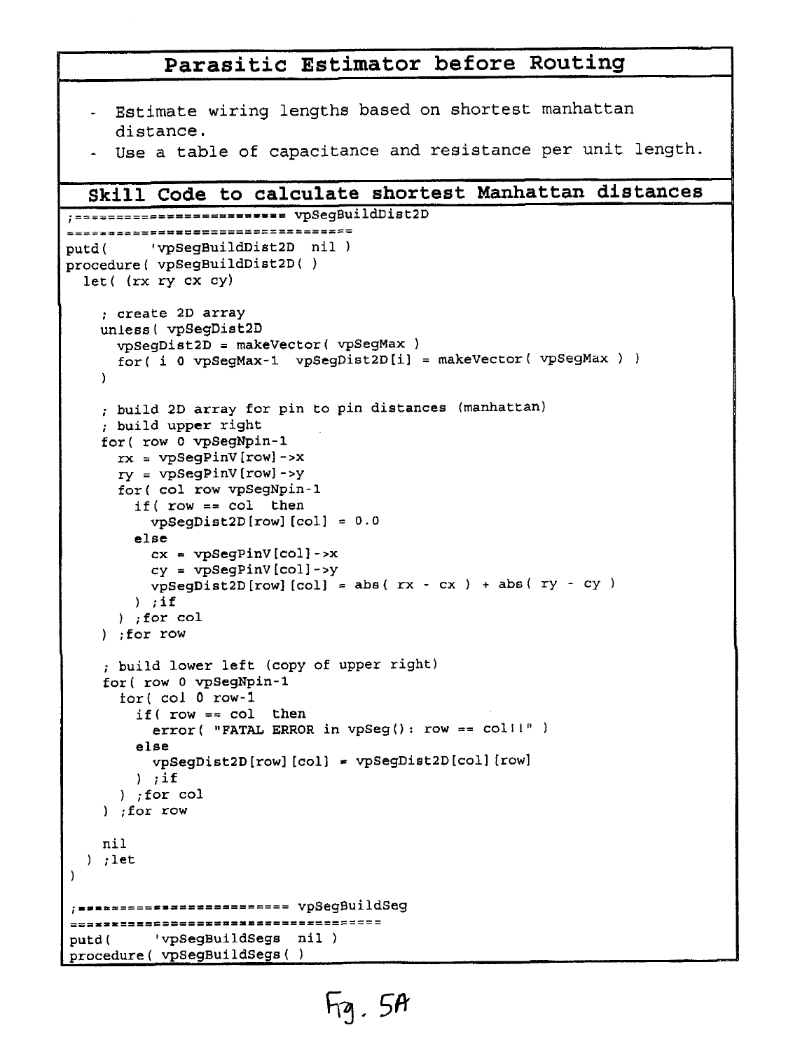

FIG. 4A-D comprises C code to calculate an estimated leaf cell parasitic capacitance, consistent with an example embodiment of the invention. This example is consistent with element 111 of FIG. 1, and with 301 of FIG. 3, and is used to calculate estimated leaf cell parasitic capacitances in a custom-written C code application.

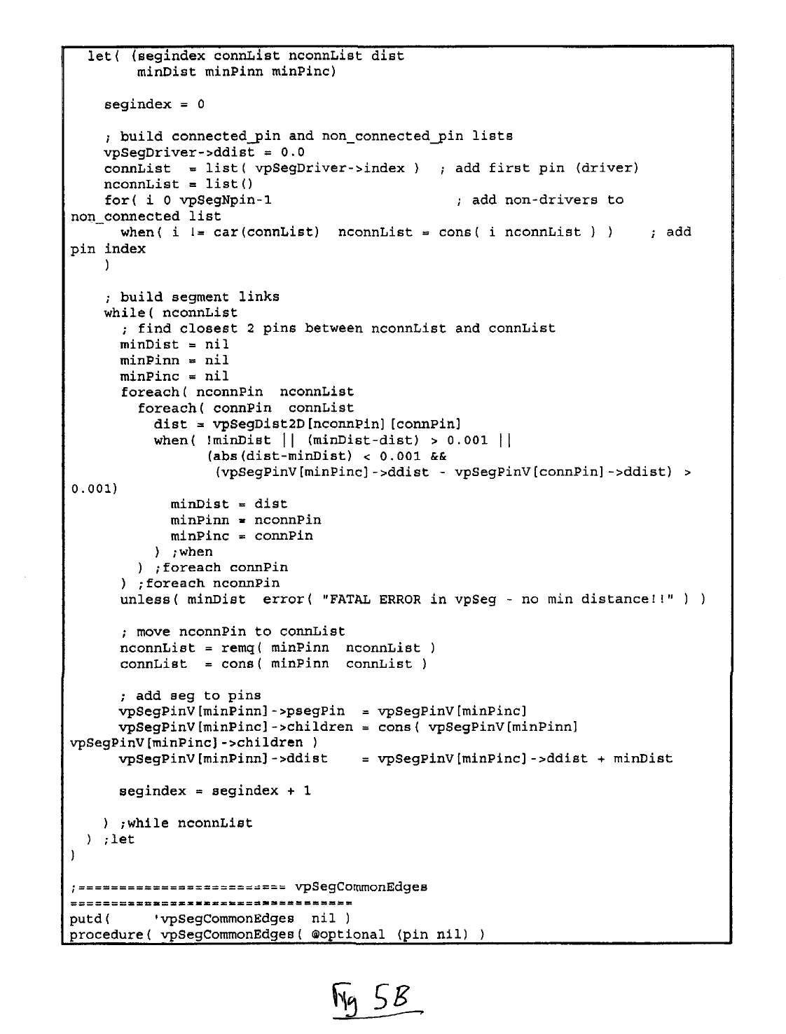

Similarly, FIG. 5A-B comprises SKILL code to calculate shortest Manhattan distances, consistent with an example embodiment of the invention. Here, the example code performs the function of element 113 of FIG. 1, or of element 303 of FIG. 3, using SKILL code. The right angle, or Manhattan distance between pins is calculated, and the shortest total Manhattan distance for each net is calculated as described in FIG. 3B at 303.

In other embodiments of the invention, other such methods are employed to perform similar functions, such as estimating parasitic resistance and capacitance in a leaf cell or circuit by application of wire models to a leaf cell or circuit of a specific area. These and other methods and devices will help the circuit designer estimate parasitic capacitance while laying out or comparing leaf cell or other circuit designs, and while incorporating leaf cells or other circuit elements into larger circuits.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

What is claimed is:

1. A method of estimating parasitic impedances in a circuit, comprising:
estimating leaf cell parasitic impedances for at least one node of two or more leaf cells;
placing the two or more leaf cells in a physical layout;
estimating interconnect wiring parasitic impedances;
placing interconnect wire routing linking nodes of at least two of the two or more leaf cells; and
estimating parasitic impedances of the circuit using parasitic reduction after estimating parasitic impedances and placing the two or more leaf cells and the interconnect wiring.

2. The method of claim 1, wherein the estimating leaf cell parasitic impedances; placing leaf cells in a physical layout, and estimating interconnect wiring parasitic impedances are performed before performing interconnect wire routing.

3. The method of claim 1, wherein placing interconnect wiring parasitic impedances and placing interconnect wire routing are repeated until satisfactory wiring parasitic impedances are obtained.

4. The method of claim 1, wherein an area wire load model is used to estimate interconnect wiring parasitic impedances.

5. The method of claim 1, wherein a shortest manhattan distance model is used to estimate interconnect wiring parasitic impedances.

6. The method of claim 1, wherein parasitic impedances are estimated for multiple interconnect wire routings.

7. The method of claim 1, wherein parasitic impedances are estimated for multiple leaf cell physical layouts.

8. The method of claim 1, further comprising running a circuit performance test using the estimated parasitic impedances of the circuit.

9. A machine-readable medium with instructions stored thereon, the instructions when executed operable to cause a computerized system to:
estimate leaf cell parasitic impedances for at least one node of two or more leaf cells;
place the two or more leaf cells in a physical layout;
estimate interconnect wiring parasitic impedances;
place interconnect wire routing linking nodes of at least two of the two or more leaf cells; and
estimate parasitic impedances of the circuit using parasitic reduction after estimating parasitic impedances and placing the two or more leaf cells and the interconnect wiring.

10. The method of claim 9, wherein the estimating leaf cell parasitic impedances; placing leaf cells in a physical layout, and estimating interconnect wiring parasitic impedances are performed before performing interconnect wire routing.

11. The method of claim 9, wherein placing interconnect wiring parasitic impedances and placing interconnect wire routing are repeated until satisfactory wiring parasitic impedances are obtained.

12. The method of claim 9, wherein an area wire load model is used to estimate interconnect wiring parasitic impedances.

13. The method of claim 9, wherein a shortest Manhattan distance model is used to estimate interconnect wiring parasitic impedances.

14. The method of claim 9, wherein parasitic impedances are estimated for multiple interconnect wire routings.

15. The method of claim 9, wherein parasitic impedances are estimated for multiple leaf cell physical layouts.

16. The method of claim 9, the instructions when executed further operable to cause the computerized system to run a circuit performance test using the estimated parasitic impedances of the circuit.

17. An electronic circuit layout system, comprising elements for:
estimating leaf cell parasitic impedances for at least one node of two or more leaf cells;
placing the two or more leaf cells in a physical layout;
estimating interconnect wiring parasitic impedances;
placing interconnect wire routing linking nodes of at least two of the two or more leaf cells; and
estimating parasitic impedances of the circuit using parasitic reduction after estimating parasitic impedances and placing the two or more leaf cells and the interconnect wiring.

18. The electronic circuit layout system of claim 17, wherein the estimating leaf cell parasitic impedances; placing leaf cells in a physical layout, and estimating interconnect wiring parasitic impedances are performed before performing interconnect wire routing.

19. The electronic circuit layout system of claim 17, wherein placing interconnect wiring parasitic impedances and placing interconnect wire routing are repeated until satisfactory wiring parasitic impedances are obtained.

20. The electronic circuit layout system of claim 17, wherein an area wire load model is used to estimate interconnect wiring parasitic impedances.

21. The electronic circuit layout system of claim 17, wherein a shortest manhattan distance model is used to estimate interconnect wiring parasitic impedances.

22. The electronic circuit layout system of claim 17, wherein parasitic impedances are estimated for multiple interconnect wire routings.

23. The electronic circuit layout system of claim 17, wherein parasitic impedances are estimated for multiple leaf cell physical layouts.

24. The electronic circuit layout system of claim 17, further comprising running a circuit performance test using the estimated parasitic impedances of the circuit.

25. A method of estimating parasitic impedances in a circuit, comprising:
estimating average parasitic impedances per wire length;
determining the area of a circuit;
estimating an average wire length per circuit area; and
applying the estimated parasitic impedances per wire length and the estimated average wire length per circuit area to the determined area of a circuit to estimate the circuit's parasitic impedance.

26. The method of estimating parasitic impedances in a circuit of claim 25, further comprising estimating parasitic impedances of the circuit using parasitic reduction.

27. The method of claim 25, wherein the circuit comprises a leaf cell.

28. The method of claim 25, further comprising estimating the parasitic impedance of one or more nets within the circuit by applying a model based on physical dimensions of the one or more nets and known parasitic impedances of nets of known physical dimensions; and
incorporating the estimated parasitic impedances of the one or more nets within the circuit into the estimated parasitic impedances in the circuit.
